(19) United States
(12) Patent Application Publication
(10) Pub. No.: US 2013/0019284 A1
(43) Pub. Date: Jan. 17, 2013

(54) AUTOMATED WEB BASED APPLICATIONS WITH A WIRELESS COMMUNICATION DEVICE

(71) Applicants: James W. Pacyga, Seattle, WA (US); Russel M. Stromberg, Seattle, WA (US)

(72) Inventors: James W. Pacyga, Seattle, WA (US); Russel M. Stromberg, Seattle, WA (US)

(21) Appl. No.: 13/492,673

(22) Filed: Jun. 8, 2012

Related U.S. Application Data
(60) Provisional application No. 61/495,812, filed on Jun. 10, 2011.
(60) Provisional application No. 61/498,820, filed on Jun. 20, 2011.

(51) Int. Cl. G06F 21/20

(52) U.S. Cl. 726/4

(57) ABSTRACT

A method for automating one or more web-based applications associated with unique identification (UID) displayed on objects and read with a wireless communication device able to connect to a remote server with no human intervention required after the UID is read is disclosed.

The wireless communication device receives data from a remote source after it has been activated. Data is then sent to a remote server. The remote server is wirelessly coupled to the wireless communication device. The server comprises applications which perform operations based on the data received from the wireless communication device. User identification is sent from the wireless communication device and the server looks up user account information stored on the server in order to access and request web based applications to complete workflow on behalf of the user with no further human intervention, unless otherwise required by the web based application.

### CROSS REFERENCE TO RELATED APPLICATIONS

This application claims priority to and benefit of co-pending U.S. patent application Ser. No. 61/495,812 filed on Jun. 10, 2011 entitled “AUTOMATING MOBILE APPLICATIONS ACTIVITIES VIA TAGGING” by James W. Pacyga, having Attorney Docket No. IOTA-004.PRO.

This application claims priority to and benefit of co-pending U.S. Patent Application No. 61/498,820 filed on Jun. 20, 2011 entitled “AUTOMATING MOBILE APPLICATIONS ACTIVITIES VIA TAGGING” by James W. Pacyga, having Attorney Docket No. IOTA-004.PRO2.

### BACKGROUND

Automatic Identification and Data Capture (AIDC) refers to the methods of automatically identifying objects, collecting data about them, and entering that data directly into computer systems (i.e. without human involvement). Technologies typically considered as part of AIDC include bar codes, Radio Frequency Identification (RFID), biometrics, magnetic stripes, Optical Character Recognition (OCR), smart cards, and voice recognition. AIDC is the process or means of obtaining external data, particularly through analysis of images, sounds or videos. To capture data, a transducer is employed which converts the actual image or a sound into a digital file. The file is then stored and at a later time it can be analyzed by a computer, or compared with other files in a database to verify identity or to provide authorization to enter a secured system. Capturing of data can be done in various ways; the best method depends on the application.

### DISCLOSURE

A system that 1) associates the unique identification symbology (UID) of barcodes and RFID tags to a server that associates the UID with one or more web based applications; 2) registers account and identification information of users and their wireless communication devices, capable of reading the barcodes and RFIDs; 3) upon the user reading the barcode or tag UID with their wireless communication device, the wireless communication device automatically sends the UID, device/user ID to a server that performs an operation authenticate the user's permissions and account information needed to sign in to web based application(s) with the web based applications assigned to the UID, and 4) if the user's account supports access to such web applications, the server authorizes and requests the web based applications to automatically execute workflow on behalf of the user with no further human intervention (unless otherwise required by the web based application.) The web based applications are remotely executed from the server by a third party private sector enterprise or public sector entity or, for personal use, the user who associates their own web based application. The server operation utilizes function calls such as private or public Application Program Interfaces to authorize and request web based applications. UIDs for barcodes and tags are registered on the server and associated with calls to web based applications. Prior to reading tags or barcodes, the user registers their wireless communication device and user identification (device/user ID) to a server. For example, the user can register with a social network single sign on credential and email address. After registration, the user has the option to access their account to manage additional personal identification information and rules associated with web based applications. The user may also register one or more wireless communication device to their account. After registering the device/user ID to the server, the user is able to wake an application on the wireless communication device to read a tag or barcode with a gesture; no further user action is required. The wireless communication device application may continue to run in the background for additional tag and barcode reading with a gesture. The tag or barcode is visually and/or audibly presented in a manner that the user is able to identify that an operation will result upon reading the barcode or tag with their wireless communication device. Upon reading the tag or barcode identification from a tag or a barcode, the wireless communication device forwards the tag or barcode UID along with all or a unique portion of the device/user ID to a remote server. The server is part of a remote service that receives the both the tag or barcode UID and the device/user ID, looks up the web based application associated with the UID, authenticates the user permissions allow access to the web based application and requests the application to perform a workflow or service on behalf of the user. Upon user authentication and request, the web based application is able to perform a service for the user without any further human intervention. The web-based application may call upon a computing device, system or third party to further interact with the user at that time or later through various endpoints, including but not limited to the user's various Internet connected devices, including but not limited to the registered wireless communication device, or an alternative third party device accessible to the user. The tag or barcode may also be associated with multiple web based applications. Service providers or others who manages the tag or barcode can dynamically modify the web-based applications associated with the tag or bar code in real time.

### BRIEF DESCRIPTION OF THE DRAWINGS

The accompanying drawings, which are incorporated in and form a part of this application, illustrate embodiments of the present invention, and together with the description, serve to explain the principles of the invention. Unless noted, the drawings referred to in this description should be understood as not being drawn to scale.

FIG. 1 shows an example system upon which embodiments of the present invention may be implemented, in accordance with various embodiments.

FIG. 2 shows an example block diagram of which embodiments of the wireless communication device may be implemented, in accordance with various embodiments.

FIG. 3 shows an example block diagram of a wireless communication device, in accordance with various embodiments.

FIG. 4 shows an example system upon which embodiments of the present invention may be implemented, in accordance with various embodiments.

FIG. 5 shows an example system upon which embodiments of the present invention may be implemented, in accordance with various embodiments.

FIG. 6 is an example flow charts for implementing web-based applications using a wireless communication device, in accordance with various embodiments.

FIG. 7 is an example flow charts for implementing web-based applications using a wireless communication device, in accordance with various embodiments.

FIG. 8 is a block diagram of a system used in accordance one embodiment.

### DESCRIPTION OF EMBODIMENTS

Reference will now be made in detail to various embodiments, examples of which are illustrated in the accompanying drawings. While the subject matter will be described in conjunction with these embodiments, it will be understood that they are not intended to limit the subject matter to these embodiments. Furthermore, in the following description, numerous specific details are set forth in order to provide a thorough understanding of the subject matter. In other instances, conventional methods, procedures, objects, and circuits have not been described in detail as not to unnecessarily obscure aspects of the subject matter.

### Notation and Nomenclature

Unless specifically stated otherwise as apparent from the following discussions, it is appreciated that throughout the present Description of Embodiments, discussions utilizing terms such as “receiving,” “sending,” “performing,” “transmitting,” “authorizing,” “requesting,” or the like, refer to the actions and processes of a computer system or similar electronic computing device (or portion thereof) such as, but not limited to: an electronic control module, a field programmable gate array (FPGA), an application-specific integrated circuit (ASIC), and/or a management system (or portion thereof). The electronic computing device manipulates and transforms data represented as physical (electronic) quantities within the electronic computing device's processors, registers, and/or memories into other data similarly represented as physical quantities within the electronic computing device's memories, registers and/or other such information storage, processing, transmission, or/or display components of the electronic computing device or other electronic computing device(s).

### Overview of Discussion

Example techniques, devices, systems, and methods for automated web based applications with a wireless communication device are described herein. Discussion begins with a high level description of a wireless communication device. Example web servers are then described. Discussion continues example procedures to activate a wireless communication device. Web based applications are then described. Next, example methods of use are described. Lastly, an example computer environment is described.

AIDC, as discussed in the background, refers to the methods of recognizing objects, getting information about them and entering that data or feeding it directly into computer systems without any human involvement. Automatic identification and data capture technologies include one dimensional barcodes, two dimensional barcodes, Radio Frequency Identification (RFID), Near Field Communications (NFC), barcodes, Optical Character Recognition (OCR), magnetic stripes, smart cards and biometrics (like iris, audio, fingerprint and facial recognition system). Typically barcodes and RFID tags use Universal Product Codes, Electronic Product Codes, and other data to allow a computer system to look up information about the product or object stored in a database. Typically, barcodes and RFID are used to accurately manage the supply, sales and support of products. Today, consumers with smartphones open up an application, scan one-dimensional (1D) barcodes on consumer package goods to retrieve product information or competitive pricing from various retailers. Today, consumers with smartphones scan two-dimensional (2D) barcodes (also known as matrix codes) to decode a phone number, text message, contact information or URL which they can then use to interact with a related application like a dialer, messenger, contact list or web browser. Today, consumers with NFC phones can upload data stored in the memory of an RFID tag such as a web site URL, product information and multi-media files. Today, consumers with NFC phones, NFC cards or RFID cards can touch an active NFC terminal at the point of sale to securely share their payment credentials with the retailer's payment system to complete a credit card transaction. The same consumers can also share their account information by touching their NFC phone to other active NFC readers to exchange files and access venues with tickets or other credentials. Typically, NFC devices and RFID cards are associated with a single or limited number of credentials authorized by the issuer of the NFC device or RFID tag.

### Wireless Communication Device

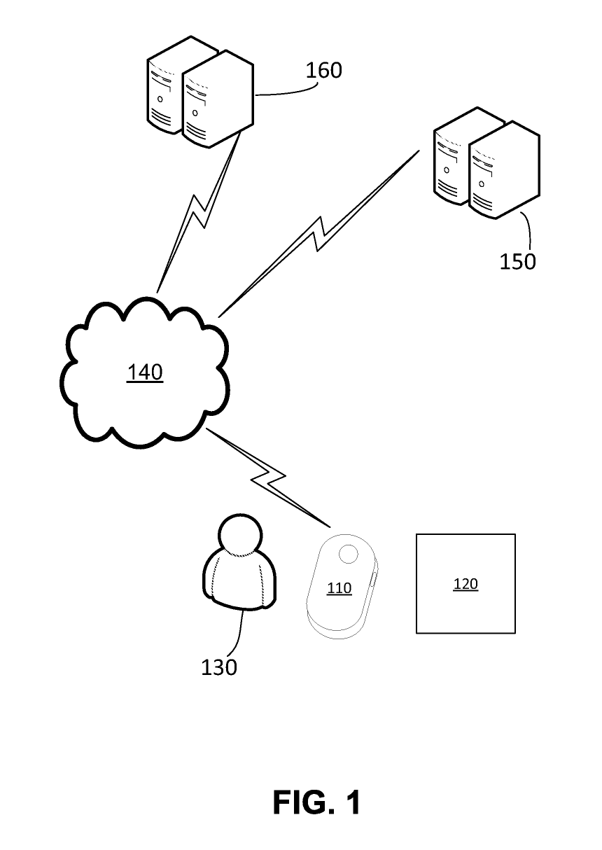

FIG. 1 shows an example system comprising a wireless communication device 110, a label 120, a user 130, a network 140, and a server 150.

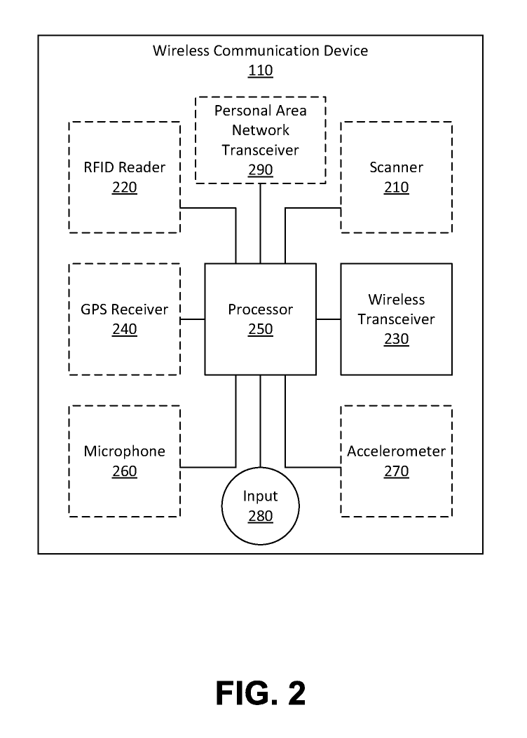

FIG. 2 shows an example block diagram of wireless communication device 110 comprising, in one embodiment, a barcode, including two-dimensional (2D) barcode, scanner 210, a radio-frequency identification (RFID) reader 220, that may communicate using Near Field Communication technology, a wireless wide area network (WWAN) transceiver 230, wireless local area network (WLAN) transceiver, a global positioning system (GPS) receiver 240, a processor 250, a microphone 260, an accelerometer 270, biometric input 280, personal area network transceiver (PAN) 290, and a physical input 280, including buttons, touch material, biometric and gesture technology. In some embodiments processor 250 controls when to activate wireless communication device 110, and communication between modules comprising wireless communication device 110. In some embodiments, wireless communication device 110 is consists of either or both WWAN transceiver 230 or WLAN transceiver in order to connect to the remote server 150. In some embodiments, the wireless communication device consists of a scanner 210 and/or RFID reader 220 to read barcodes and tags. In some embodiments, wireless communication device consists of a microphone 260, accelerometer 270 and/or button 280, including touch material or screen to allow the user and/or device to initiate the tag or barcode reading application. In some embodiments, wireless communication device 110 may include biometric input 280 and an application to provide unique user 130 authorization to access the wireless communication device and/or reading of tags and barcode. In some embodiments, wireless communication device 110 may include one or both GPS receiver 240 or accelerometer 270 for additional location and motion based data to be sent to the server 150 in connection with reading tag and barcode identifiers.

In some embodiments, wireless communication device 110 is not a stand-alone device. In some embodiments wireless communication device 110 is a cell phone or smart phone. In some embodiments wireless communication device 110 is a card that fits into a wallet. In some embodiments wireless communication device 110 is a badge. In some embodiments wireless communication device 110 is a wearable accessory, such as a bracelet or watch. In some embodiments wireless communication device 110 is module that fits in a shoe. In some embodiments wireless communication device 110 is a device that clips to the clothing of a user 130. In some embodiments wireless communication device 110 has no clip and fits in a pocket or bag.

In some embodiments label 120 is various types of barcodes or other scannable codes in print media. In some embodiments label 120 is an image or word. When the label 120 is a barcode, the wireless communication device 110 uses barcode scanner 210 to scan the barcode.

In some embodiments label 120 is an RFID tag. When the label 120 is an RFID tag, wireless communication device 110 uses RFID reader 220 to receive data from the RFID tag/label 120. In some embodiments label 120 communicates with wireless communication device 110 via the Near Field Communication standard. In some embodiments label 120 communicates with wireless communication device 110 via the ultra-high frequency band (UHF). When label 120 communicates using near field communication, the wireless communication device 110 must come in close proximity (e.g., within a few centimeters) or touch/tap label 120 to receive the data contained in the tag. It should be understood that touch and tap, as used herein are synonymous. When label 120 communicates via UHF, the RFID tag/label 120 can be read at further distances than when label 120 communicates via near field communication.

After reading a label 120, wireless communication device 110 sends data to server 150 via wireless transceiver 230. In some embodiments, wireless transceiver 230 may transmit and receive signals. In some embodiments wireless transceiver 230 only sends signals and does not receive signals. In some embodiments, transceiver 230 receives signals to update the software and/or firmware of wireless communication device 110.

In some embodiments, after or in parallel to reading a label 120 wireless communication device 110 receives location information via GPS receiver 240, the WWAN transceiver or WLAN transceiver. In some embodiments wireless communication device 110 sends location information to server 150.

After reading a label 120, wireless communication device 110 sends data to server 150 including, but not limited to: a user/account identification (UID), data read from label 120. Wireless communication device 110 may also send data to server 150 one or more of the following data: location information, accelerometer data, and data from processor 250 after processor 250 has performed various operations data received from label 120. In some embodiments, after reading label 120 wireless communication device 110 sends a UID and the data read from label 120 to server 150.

### Example Web Server

As discussed above, FIG. 1 shows an example system in accordance with one embodiment. In some embodiments, after user 130 captures data from label 120 with wireless communication device 110, wireless communications device 110 transmits data through network 140 to server 150. In some embodiments, a user 130 performs a gesture such as pressing a button 280 or providing a voice command for wireless communication device 110 to scan a barcode or tag 120. Processor 250 performs the scan and sends data to Server 150. Server 150 is able to communicate with a plurality of web servers/services 160 and applications 160 including, but not limited to: social networking services, online gaming services, streaming media services, email services, music services, ticketing services, coupon/deal services, cloud storage services, digital calendars, travel services, banking services, health care services, publishers, campaigns, consumer brands, government services, employers, home networks, restaurants, retail stores, theaters, arenas, museums, office buildings, airports, mass transit, convention centers, outdoor festivals, fitness centers, malls, amusement parks, public parks, etc.

In some embodiments user 130 may set up an account on server 150 to customize the operations server 150 performs in response to data sent from their wireless communication device 110. For example, user 130 may add network logins, single sign on credentials, email accounts, financial accounts, membership accounts, loyalty cards, rewards program accounts, physical mailing addresses, health information and other personal identification information. For example, a user 130 may program their account so that it can create notifications for certain transactions, limit access to personal information, limit sharing information to certain accounts, prioritize credit card numbers to be accessed, create notifications for certain transactions, and block purchase of certain goods such as fast food.

For the purposes of this disclosure, server 150 may be a single server, a server cluster, distributed clusters, a cloud, etc. Server 150 comprises at least one application that receives data from wireless communication device 110 and performs operations based on the data. In some embodiments, an application in server 150 comprises a look-up table such that when data is received from wireless communication device 110, the application finds within the look up table at least one operation associated with the tag or barcode to perform.

In some embodiments, server 150 comprises the personal information of user 130. This allows wireless communication device 110 to send a UID and perform operations without additional user input. For example, server 150 may store the usernames and passwords belonging to user 130 so that server 150 may access a Facebook™, Twitter™, or LinkedIn™ account. Server 150 may also store credit card, debit card, and/or bank account information such that user 130 may purchase goods and services with wireless communication device 110.

Server 150 may perform a plurality of operations after it receives data from wireless communication device 110. These examples are not meant to limit the operations server 150 may perform. Instead, they are meant to provide a thorough understanding of the subject matter. In some embodiments, server 150 may authorize a web based application to post on the Facebook™, Google Plus™, and/or LinkedIn™ wall of user 130. In some embodiments, server 150 may authorize a web based application to post a video and/or “Like” something on Facebook™. In some embodiments server 150 may authorize a web based application to “check-in” on Foursquare™ and/or Facebook™. In some embodiments server 150 may authorize a web based application to “pin” something to the Pinterest™ board of user 130. Further, server 150 may authorize a web based application or trusted service manager to charge the credit card or bank account of user 130 in some embodiments. In some embodiments server 150 may authorize a web based application, SMS gateway, or email service to send an SMS or an email to user 130. In some embodiments, when a user 130 checks in at a location an SMS, email or social network message may be sent to a computing device of user 130 or someone else. In some embodiments, server 150 may authorize a web based application to deliver coupons to a user 130. In some embodiments, server 150 may request a web based application to cue a multi-media experience in a venue user 130 is visiting. In some embodiments, server 150 may authorize a web based application to notify a venue to grant user 130 access to common areas, restricted areas or a specific seat location. In some embodiments, server 150 may authorize a web based application to deliver multi-media content to the user 130′s email account, social network accounts, online storage account or multimedia accounts, such as, but not limited to, iTunes™, XBOX Live™, Netflix™, and YouTube™. In some embodiments, server 150 may authorize a publisher to deliver content and promotions to the email and social network accounts of user 130 on behalf of an advertiser. In some embodiments, server 150 may pass additional identification information stored in user 130's account to an IT system to login or provide secondary identification in a login process to a computer session or web based application. In some embodiments, server 150 may authorize and/or request one or more business entity servers to execute one or more web based applications or other services on behalf of user 130. In some embodiments server 150 may perform a plurality of these operations. In some embodiments server 150 may provide analytics on the traffic patterns across a plurality of tags and barcodes cross referenced with a plurality of user and a plurality of web based applications. In some embodiments server 150 may process, deliver or request analytics on Internet traffic patterns, various real world traffic patterns, mobile network traffic, supply chain, marketing, services, sales, trends, forecasts, demographics and population behaviors. In some embodiments, server 150 may modify the operation associated with a tag or barcode based upon rules provided to server 150 in associated with the registered tag or barcode. In some embodiments, server 150 may modify the operation associated with the tag or barcode based upon user behavior, traffic patterns, metrics, analytics, trends, or other monitored data processed or received. For example, server 150 can suspend a user 130 account if a tag is scanned in a location that is outside of defined radius of the last tag scanned for that account. For example, server 150 can authorize a web based application to reward a user 130 based upon the frequency of user 130 scan certain branded tags. For example, server 150 can modify the operation associated with a plurality of tags managed by a consumer based upon trends or events in an ad campaign. For example, server 150 can provide information to brands of user trends across a plurality of barcodes and tags, so that brands can respond in their marketing campaigns which may or may not include management of tags and barcodes registered to server 150.

In some embodiments the server 150 may receive data which it does not recognize, or receive data which it cannot perform. In some embodiments, the wireless communication device 110 comprises a light, voice, or sound that indicates that an operation was not completed. For example, if a user 130 uses their wireless communication device 110 to purchase an item and their credit card is not accepted or their bank account does not have sufficient funds the wireless communication device may make a particular sound or, if a display is available, display a message. In some embodiments, if a user 130 uses their wireless communication device 110 to scan a tag or barcode that is not registered to server 150, then server 150 may alert user 130 through sensory feedback on wireless communication device 110, through messages to a display, or log details about the event in a history file that user 130 can access through their account. For example, if user 130 scans a barcode encoded with a web site address URL rather than an identifier registered to server 150, then server 150 can store the web site address in user 130 account usage history so that, at a time of user 130's choosing, user 130 can access the URL through their usage history records. In this same example, sever 150 can request a web based application to alert the owner of the URL that an anonymous person scanned their Barcode. For example, if user 130 scans a bar code on a consumer packaged good, such as a bag of chips, that is not registered to server 150, then server 150 can access third party databases, if available, to retrieve information on the consumer packaged good and record it to the user 130 account usage history so that, at a time of user 130's choosing, user 130 can recall information on the consumer packaged good through their usage history records. In the two aforementioned examples, sever 150 can request a web based application to alert the owner of the URL or consumer packaged good that an anonymous person or user 130, to the extent user 130 and server 150 business rules authorizes user 130 profile to be shared, scanned the barcode not registered to server 150.

### Example Procedures to Activate a Wireless Communication Device

In some embodiments, once wireless communication device 110 is activated, it will automatically scan an identifying code from a tag 120 (in the case of a barcode) or read an identification from a label 120 (in the case of an RFID tag), send data to server 150, and server 150 will perform at least one corresponding operation. In some embodiments, neither additional input nor additional action is required by user 130 for server 150 to perform at least one corresponding operation. Note that the term activate, as used in various embodiments herein, refers to activating the input devices within wireless communication device 110 such that they automatically receive data and send data to server 150. In an embodiment, wireless communication device 110 is already powered on (e.g., in resting mode), but is not activated such that it is receiving data.

For example, after wireless communication device 110 is activated, user 130 may simply tap a tag 120 with communication device 110 to purchase the item attached to label 120. A single tap is similar to a “one-click” button used in websites. In some embodiments, user 130 does not need to perform any action other than tapping label 120 with wireless communication device 110 to purchase the item. In some embodiments, no additional input is required from user 130 for server 150 to perform the corresponding operation. In some embodiments the workflow is reduced since a user 130 does not need to perform as many actions.

In some embodiments, user 130 gestures to activate wireless communication device 110. Gestures may include, but are not limited to: pressing a button 280 on wireless communication device 110, moving wireless communication device 110, speaking, waving an object in front of wireless communication device 110, etc.

In one embodiment, user 130 presses a button 200 to activate wireless communication device 110. In some embodiments the button 200 may be a physical button 200. In other embodiments the button 200 may be on a touch screen (e.g., when wireless communication device is a smart phone).

In one embodiment, wireless communication device 110 is activated when it is moved. In other words, in some embodiments wireless communication device is activated when it changes from an immobile state to a mobile state. In some embodiments, accelerometer 270 detects when wireless communication device 110 moves.

In one embodiment, wireless communication device 110 is activated when user 130 speaks. In some embodiments microphone 260 allows wireless communication device 110 to capture sound. In some embodiments wireless communication device 110 is programmed to recognize the voice of user 130. In some embodiments, a user 130 may say a specific word to activate wireless communication device 110. For example, user 130 may say “activate wireless communication device” to activate wireless communication device 110. In some embodiments the user may simply say “activate.” These are meant to be examples, and the spoken command to activate wireless communication device 110 may be anything.

In some embodiments, user 110 may program wireless communication device 110 such that it activates to a particular spoken command or a plurality of spoken commands. In some embodiments, a particular spoken command may activate wireless communication device 110 such that only particular operations may be performed by server 150. For example, wireless communications device 110 may receive a spoken command such that processor 250 sends data to server 150 indicating that only particular operations may be performed. For example, if the spoken command is “Like,” the user 130 may only use wireless communication device to “Like” something on Facebook™ and user 130 may not use wireless communication device 110 to purchase anything.

### Web Based Applications

The following scenarios and applications are not meant to limit embodiments. Instead, they are meant to provide a thorough understanding of the subject matter.

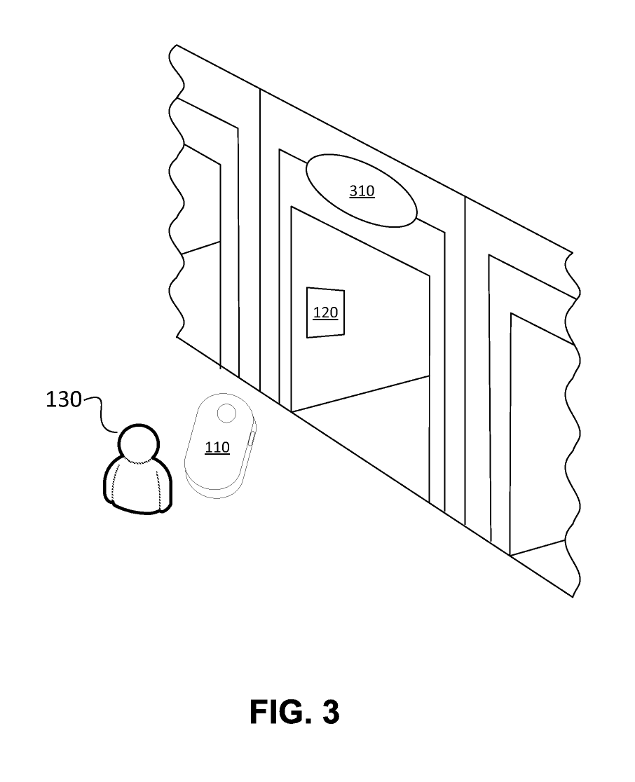

FIG. 3 shows one embodiment in which a user 130 may use wireless communication device to “check in” to a location 310. If the wireless communication device 110 is already activated, user 130 may tap the label 120 on the wall of location 310. If an RFID tag at location 310 communicates via UHF, user 130 may automatically be checked in when they walk into location 310. In some embodiments a first user 130 may tap their wireless communication device 110 to the wireless communication device 110 of a second user, and then tap label 120 to check in both the first user and the second user. In some embodiments, after tapping the wireless communication device 110 of a second user, server 150 may perform other operations that require accessing accounts of both a first user 130 and a second user 130.

In some embodiments, label 120 is attached to a poster of a musician. If user 130 taps the poster, in one embodiment, the user will “Like” the musician on Facebook™. In another embodiment, the user will download the album the poster is advertising. In one embodiment, the label 120 may cause the user to download the music playing in location 310. For example, if a user 130 likes the music playing in a store/location 310 and wants to download the music playing in that store, they may tap a label 120 allowing them to download the music playing in the store. Codes on TV, billboards, buses, magazines, or projected on walls may also be read by wireless communications device 110.

In some embodiments, a user may program an account to instruct server 150 as to where to download data. For instance, a user 130 may configure their account to download data (e.g., music, movies, etc.) to their personal computer, smart phone, or media player.

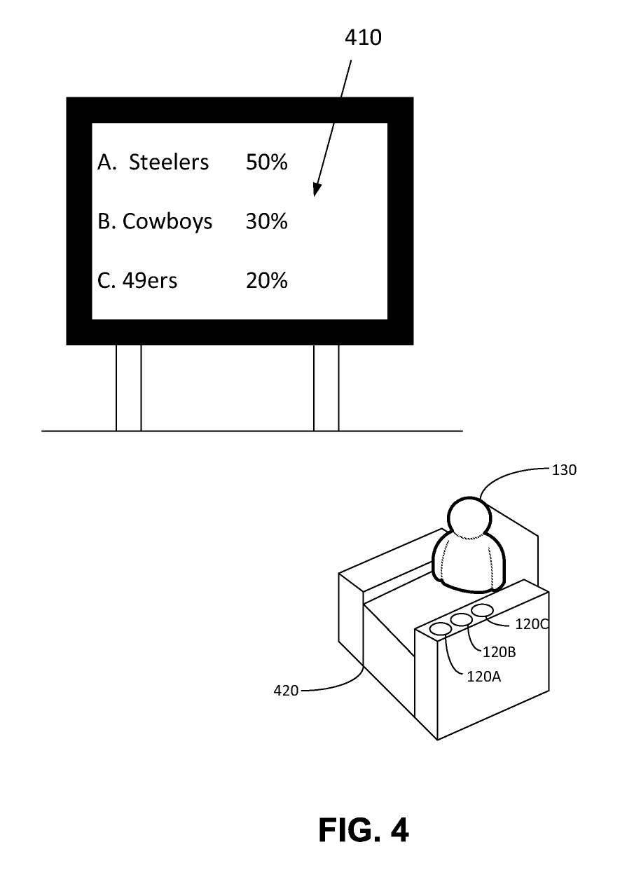

FIG. 4 shows one embodiment wherein a seat 420 in a theater or a stadium may comprise labels 120. In one example, seat 420 comprises three labels (120A, 120B, and 120C) that user 130 may tap. In one example, a screen 410 asks audience members what team has won the most super bowls. After users 130 tap one the three labels, the screen 410 displays what everyone that tapped one of the three labels 120 chose. In another example, a screen 410 may ask audience members trivia questions and then display results. In these examples, server 150 is able to connect to a system 160 connected to the screen 410.

In one embodiment, a user 130 may have to tap a label 120 to check in or out of work. If the label 120 communicates via UHF, a user 130 could merely walk by label 120.

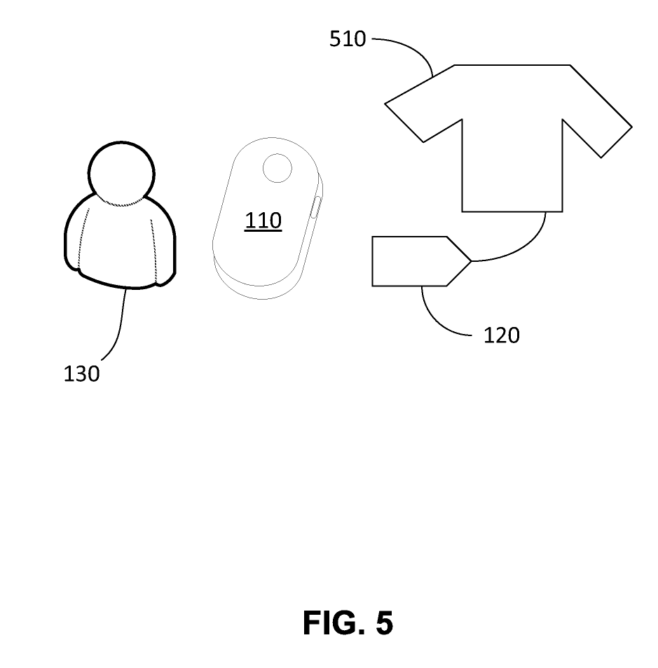

As shown FIG. 5, in one embodiment, a label 120 may be attached to a good 510. In one example, a wireless communication device 110 may tap the label and retrieve the price of the good 510. In another embodiment, after tapping the label 120 server 150 may charge the credit card or bank account of user 130. By purchasing goods 510 in this manner, user 130 does not need to wait in line at a cashier or check-out stand. In some embodiments, after a good 510 is purchased, server 150 will send a store information about the user 130 such that the store may deliver the good 510 to an address provided by the user 130.

As discussed herein, in some embodiments, wireless communication device 110 sends more data to server 150 than the data on the label 120 and the UID. In one embodiment the wireless communication device 110 tracks movement throughout a day. In some embodiments the movement is detected by accelerometer 270. In some embodiments the wireless communication device 110 sends the amount of movement to server 150. In one embodiment the wireless communication device 110 is attached to a runner before a race such that the wireless communication device 110 reads labels 120 along a route.

In one embodiment, a bracelet/band keeps track of how much a user 130 moves in a day. In one embodiment, the band is a label 120. If the user 130 pairs the band to a mobile wireless communication device 110, the data may be uploaded to server 150.

In one embodiment a delivery menu for a restaurant comprises labels 120. Rather than call the restaurant, a user 130 may simply order by tapping items on the delivery menu.

In some embodiments, wireless communication devices 110 are wearable. A wireless communication device 110 may be attached to or implanted in clothes and jewelry including, but not limited to: bracelets, necklaces, shoes, shirts, pants, hats, dresses, hospital gowns, scrubs, work clothing, etc.

### Example Methods of Operation

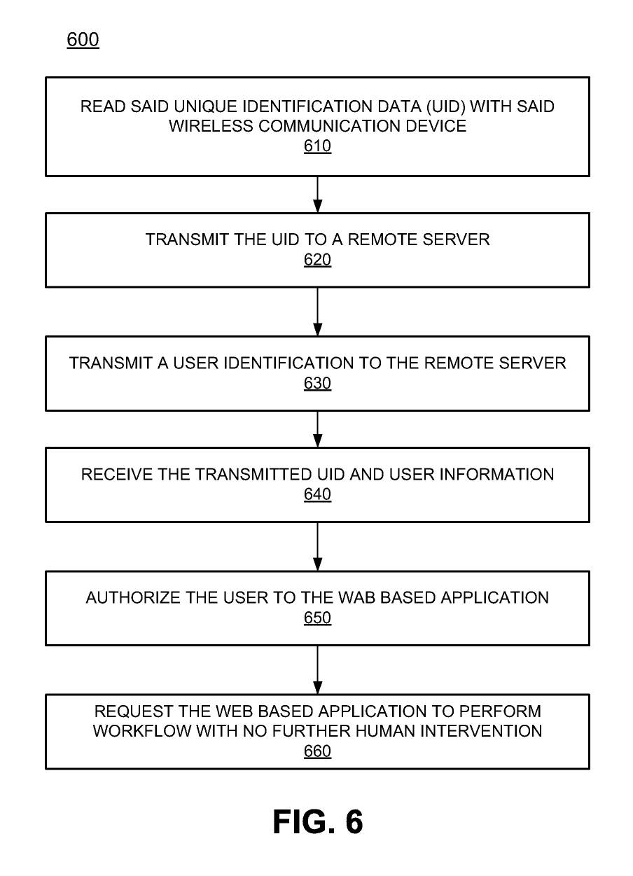

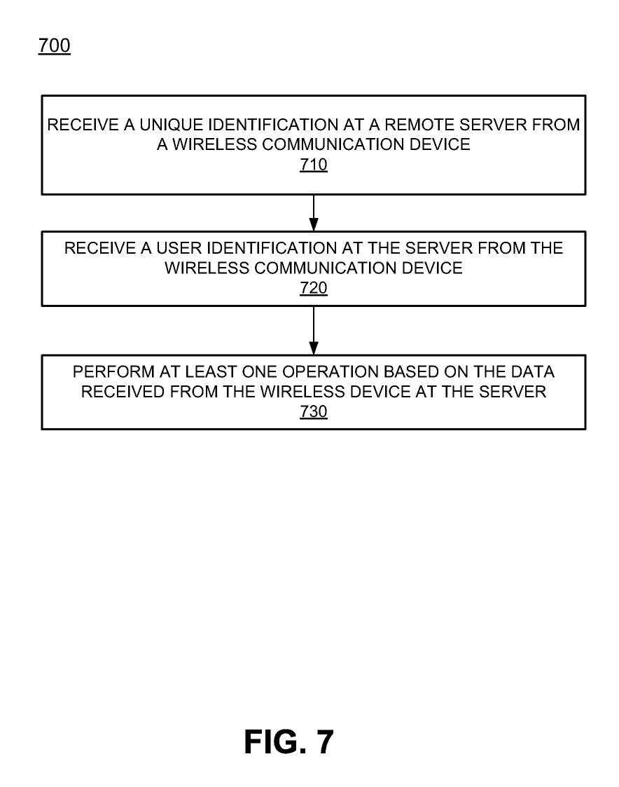

With reference to FIGS. 6 and 7, flow diagrams 600 and 700 illustrate example procedures used by various embodiments. Flow diagrams 600 and 700 include processes and operations that, in various embodiments, are carried out by one or more of the devices illustrated in FIGS. 1, 2 or via computer system 800 or components thereof.

Although specific procedures are disclosed in flow diagrams 600 and 700, such procedures are examples. That is, embodiments are well suited to performing various other operations or variations of the operations recited in the processes of flow diagrams 600 and 700. Likewise, in some embodiments, the operations in flow diagrams 600 and 700 may be performed in an order different than presented, not all of the operations described in one or more of these flow diagrams may be performed, and/or one or more additional operation may be added.

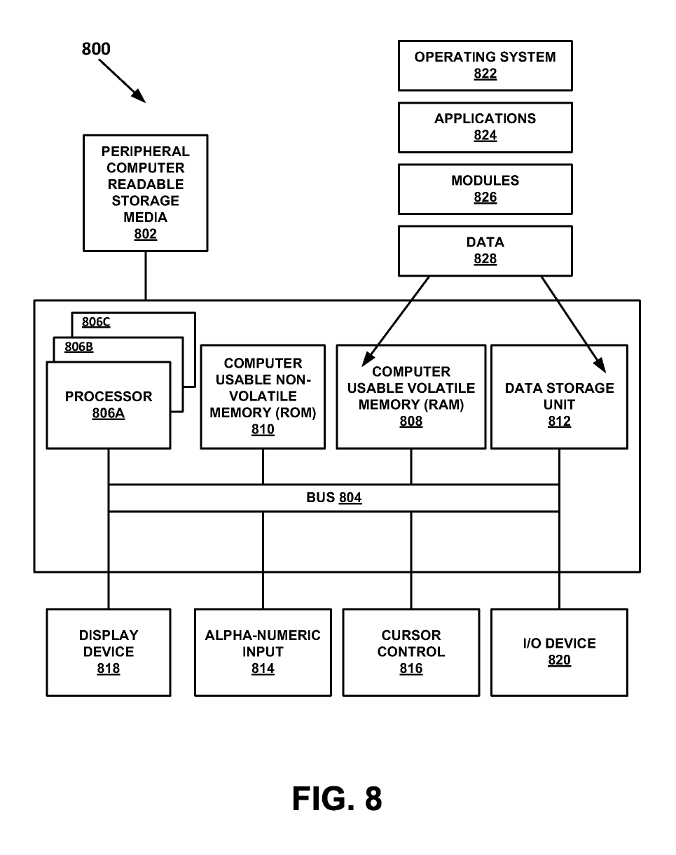

The following discussion sets forth in detail the operation of some example methods of operation of embodiments. With reference to FIGS. 6 and 7, flow diagrams 600 and 700 illustrate example procedures used by various embodiments. Flow diagrams 600 and 700 include some procedures that, in various embodiments, are carried out by a processor under the control of computer-readable and computer-executable instructions. In this fashion, procedures described herein and in conjunction with flow diagrams 600 and 700 are or may be implemented using a computer, in various embodiments. The computer-readable and computer-executable instructions can reside in any tangible computer readable storage media, such as, for example, in data storage features such as RAM 808 (e.g., SRAM, DRAM, Flash, embedded DRAM, EPROM, EEPROM, etc.), ROM 806, and/or storage device 812 (all of FIG. 8). The computer-readable and computer-executable instructions, which reside on tangible computer readable storage media, are used to control or operate in conjunction with, for example, one or some combination of processor 806A, or other similar processor(s). Although specific procedures are disclosed in flow diagrams 600 and 700, such procedures are examples. That is, embodiments are well suited to performing various other procedures or variations of the procedures recited in flow diagrams 600 and 700. Likewise, in some embodiments, the procedures in flow diagrams 600 and 700 may be performed in an order different than presented and/or not all of the procedures described in one or more procedures described in FIGS. 6 and 7 may be performed. It is further appreciated that one or more procedures described in flow diagrams 600 and 700 may be implemented in hardware, or a combination of hardware and firmware, or a combination of hardware and software running thereon.

FIG. 6 is a flow diagram 600 of an example method of automating a web-based application from a wireless communication device 110, in accordance with an embodiment. Reference will be made to elements of FIGS. 1, 2 and 8 to facilitate the explanation of the operations of the method of flow diagram 600. In one embodiment, the method of flow diagram 600 describes the use of wireless communication device 110 and server 150.

At operation 610, in one embodiment, a unique identification (UID) is read with the wireless communication device 11—such that the wireless communication device 110 receives a UID and performs all other subsequent operations performed by at least one device application without input from a user after the application to read the UID of the wireless communication device is activated. Activation may be performed as described above.

At operation 620, in one embodiment, A UID is transmitted to a remote server 150 such that the remote server 150 is wirelessly coupled to the wireless communication device 110 and such that the remote server 150 comprises an application configured to perform at least one operation on the data.

At operation 630, in one embodiment, user identification data is transmitted to the remote server 150 wherein the user identification is sent from the wireless communication device 110 and wherein the remote server 150 comprises a database comprising user accounts.

At operation 640, in one embodiment, the transmitted user identification and UID is received at the remote server wherein the remote server 150 looks up one or more web based applications 160 assigned to the UID and looks up user account information.

At operation 650, in one embodiment, the web based application 160 authorizes the user 130 access.

At operation 640, in one embodiment, the web based application 160 is requested to perform workflow with no further human intervention. Human intervention may include entering a password, providing a signature or the like.

FIG. 7 is a flow diagram 700 of an example method of automating a web-based application from a wireless communication device 110, in accordance with an embodiment. Reference will be made to elements of FIGS. 1, 2 and 8 to facilitate the explanation of the operations of the method of flow diagram 700.

At operation 710, in one embodiment, a unique identification is received at a server 150 from a wireless communication device 110, wherein the wireless communication device 110 received data from a remote source (e.g., a label 120).

At operation 720, in one embodiment, a user identification is received at the server 150 from the wireless communication device 110 wherein the user identification is stored on the wireless communication device 110, and wherein the wireless communication device 110 does not require input from a user 130 after the wireless communication device 110 is activated.

At operation 730, in one embodiment, at least one operation is performed based on the data received from the wireless communication device 110 at the server 150.

### Example Computer System Environment

With reference now to FIG. 8, all or portions of some embodiments described herein are composed of computer-readable and computer-executable instructions that reside, for example, in computer-usable/computer-readable storage media of a computer system. That is, FIG. 8 illustrates one example of a type of computer (computer system 800) that can be used in accordance with or to implement various embodiments which are discussed herein. It is appreciated that computer system 800 of FIG. 8 is an example and that embodiments as described herein can operate on or within a number of different computer systems including, but not limited to, general purpose networked computer systems, embedded computer systems, routers, switches, server devices, client devices, various intermediate devices/nodes, stand alone computer systems, media centers, handheld computer systems, multi-media devices, and the like. Computer system 800 of FIG. 8 is well adapted to having peripheral tangible computer-readable storage media 802 such as, for example, a floppy disk, a compact disc, digital versatile disc, other disc based storage, universal serial bus “thumb” drive, removable memory card, and the like coupled thereto. The tangible computer-readable storage media is non-transitory in nature.

System 800 of FIG. 8 includes an address/data bus 804 for communicating information, and a processor 806A coupled with bus 804 for processing information and instructions. As depicted in FIG. 8, system 800 is also well suited to a multi-processor environment in which a plurality of processors 806A, 806B, and 806C are present. Conversely, system 800 is also well suited to having a single processor such as, for example, processor 806A. Processors 806A, 806B, and 806C may be any of various types of microprocessors. System 800 also includes data storage features such as a computer usable volatile memory 808, e.g., random access memory (RAM), coupled with bus 804 for storing information and instructions for processors 806A, 806B, and 806C. System 800 also includes computer usable non-volatile memory 810, e.g., read only memory (ROM), coupled with bus 804 for storing static information and instructions for processors 806A, 806B, and 806C. Also present in system 800 is a data storage unit 812 (e.g., a magnetic or optical disk and disk drive) coupled with bus 804 for storing information and instructions. System 800 may also include an alphanumeric input device 814 including alphanumeric and function keys coupled with bus 804 for communicating information and command selections to processor 806A or processors 806A, 806B, and 806C. System 800 may also include cursor control device 816 coupled with bus 804 for communicating user input information and command selections to processor 806A or processors 806A, 806B, and 806C. In one embodiment, system 800 may also include display device 818 coupled with bus 804 for displaying information.

Referring still to FIG. 8, display device 818 of FIG. 8, when included, may be a liquid crystal device, cathode ray tube, plasma display device or other display device suitable for creating graphic images and alphanumeric characters recognizable to a user. Cursor control device 816, when included, allows the computer user to dynamically signal the movement of a visible symbol (cursor) on a display screen of display device 818 and indicate user selections of selectable items displayed on display device 818. Many implementations of cursor control device 816 are known in the art including a trackball, mouse, touch pad, joystick or special keys on alphanumeric input device 814 capable of signaling movement of a given direction or manner of displacement. Alternatively, it will be appreciated that a cursor can be directed and/or activated via input from alphanumeric input device 814 using special keys and key sequence commands. System 800 is also well suited to having a cursor directed by other means such as, for example, voice commands. System 800 also includes an I/O device 820 for coupling system 800 with external entities. For example, in one embodiment, I/O device 820 is a modem for enabling wired or wireless communications between system 800 and an external network such as, but not limited to, the Internet.

Referring still to FIG. 8, various other components are depicted for system 800. Specifically, when present, an operating system 822, applications 824, modules 826, and data 828 are shown as typically residing in one or some combination of computer usable volatile memory 808 (e.g., RAM), computer usable non-volatile memory 810 (e.g., ROM), and data storage unit 812. In some embodiments, all or portions of various embodiments described herein are stored, for example, as an application 824 and/or module 826 in memory locations within RAM 808, computer-readable storage media within data storage unit 812, peripheral computer-readable storage media 802, and/or other tangible computer-readable storage media.

Example embodiments of the subject matter are thus described. Although various embodiments of the subject matter have been described in a language specific to structural features and/or methodological acts, it is to be understood that the appended claims are not necessarily limited to the specific features or acts described above. Rather, the specific features and acts described above are disclosed as example forms of implementing the claims and their equivalents.

What is claimed is:

1. A method for automating one or more web-based applications associated with unique identification (UID) displayed on at least one object and read with a human managed wireless communication device able to connect to a remote server with no human intervention required after the UID is read, said method comprising:
reading said unique identification data (UID) with said wireless communication device, wherein said wireless communication device receives said UID and performs all other subsequent operations performed by at least one device application without input from a user after said application to read said UID of said wireless communication device is activated;
transmitting said UID to a remote server wherein said remote server is wirelessly coupled to said wireless communication device, and wherein said remote server comprises an application configured to perform at least one operation based on said data;
transmitting a user identification data to said remote server, wherein said user identification is sent from the wireless communication device, and wherein said remote server comprises a database of user accounts;
receiving the transmitted UID and user identification wherein said remote server looks up one or more web based applications assigned to the UID and looks up user account information that may include additional permissions, rules and identification credentials not received in a transmission, necessary to authorize access to said web based applications or related transactions;
authorizing the user to the web based application; and
requesting the web based application to perform workflow with no further human intervention.

2. The method of claim 1 wherein said UID is read from a on-dimensional (1D) barcode.

3. The method of claim 1 wherein said UID is read from a two-dimensional (2D) barcode.

4. The method of claim 1 wherein said UID is read from a near field communication device.

5. The method of claim 1 wherein said UID is read from a radio-frequency identification (RFID) tag.

6. The method of claim 5 wherein said radio-frequency identification tag is designed to transmit to near field communication devices.

7. The method of claim 5 wherein said radio-frequency identification tag transmits said data at an ultra-high frequency.

8. The method of claim 1 wherein said UID is received from a string of characters through a method of Optical Character Recognition (OCR).

9. The method of claim 1 wherein said UID is received from an audible sound through a method of audio recognition.

10. The method of claim 1 wherein said UID is received from an image through a method of image recognition.

11. The method of claim 1 wherein a wireless communication device application to read said UID is activated prior to reading said UID.

12. The method of claim 11 wherein said wireless communication device application to read said UID is activated prior to reading said UID and remains active to read a subsequent UID.

13. The method of claim 11 wherein said wireless communication device application to read said UID is activated by a user touching a button.

14. The method of claim 11 wherein said wireless communication device application to read said UID is motion activated.

15. The method of claim 11 wherein said wireless communication device application to read said UID is voice activated.

16. The method of claim 1 where the UID is encoded in a 1D barcode.

17. The method of claim 1 where the UID is encoded in a 2D barcode.

18. The method of claim 1 wherein additional data is sent to said remote server.

19. The method of claim 18 wherein said additional data is a location of said wireless communication device.

20. The method of claim 18 wherein said additional data is based on movement of said wireless communication device.

21. The method of claim 1 wherein said at least one operation is determined by a lookup table located in said remote server, wherein said lookup table receives said UID as an input.

22. The method of claim 1 wherein said data comprises information about a product, and wherein receiving said data with said wireless communication device causes a user to purchase said product.

23. The method of claim 1 wherein said data comprises information about a web site address, and wherein receiving said data with said wireless communication device causes a web based application to be performed in addition to or rather than initiating a web browser session.

24. A wireless communication device comprising:
a reader to read a UID;
a processor to decode or process said UID; and
a transmitter to send said UID and a user identification data to a remote server, wherein said remote server is wirelessly coupled to said wireless communication device, wherein said remote server comprises an application configured to perform at least one operation based on said UID, wherein said remote server stores user account information designed to authorize access to web based applications, and wherein sufficient user identification is stored on said wireless communication device for said remote server to look up user account information.

25. The wireless communication device of claim 24 wherein said reader is configured to read 1D barcodes.

26. The wireless communication device of claim 24 wherein said reader is configured to read 2D barcodes.

27. The wireless communication device of claim 24 wherein said reader is configured to read a radio-frequency identification tag.

28. The wireless communication device of claim 24 wherein a radio-frequency identification tag is designed to be read by a near field communication device.

29. The wireless communication device of claim 24 wherein a radio-frequency identification tag transmits said data at an ultra-high frequency.

30. The wireless communication device of claim 24 wherein said reader is configured to read a near field communication device.

31. A method for automating a web-based application upon reading a unique identification (UID) displayed on an object with a wireless communication device, comprising:
receiving a UID at a remote server from a wireless communication device, wherein said wireless communication device received said data from a remote source;
receiving a user identification at said server from said wireless communication device, wherein said user identification is stored on said wireless communication device, wherein said user identification is sufficient for said server to look up and utilize stored user account information and wherein said wireless communication device does not require input from a user after said wireless communication device is activated and held in a position to read the UID; and
performing at least one operation based on the data received from said wireless communication device at said server.

32. The method of claim 31 wherein said wireless communication device is activated by a gesture performed by a user.
